(19) United States
(12) Patent Application Publication
(10) Pub. No.: US 2005/0195896 A1
(43) Pub. Date: Sep. 8, 2005

(54) Architecture for stack robust fine granularity scalability

(75) Inventors: Hsiang-Chun Huang, Sinpu Township (TW); Chung-Neng Wang, Dashu Shiang (TW); Tihao Chiang, Taipei City (TW); Hsuch-Ming Hang, Hsinchu City (TW)

Correspondence Address: TROXELL LAW OFFICE PLLC, SUITE 1404, 5205 LEESBURG PIKE, FALLS CHURCH, VA, 22041, US

(73) Assignee: NATIONAL CHIAO TUNG UNIVERSITY

(21) Appl. No.: 10/793,830

(22) Filed: Mar. 8, 2004

(51) Int. Cl. H04N 7/12

(52) U.S. Cl. 375/240.03; 375/240.1; 375/240.12; 375/240.2; 375/240.23

(57) ABSTRACT

The present invention relates to an architecture for stack robust fine granularity scalability (SRFGS), more particularly, SRFGS providing simultaneously temporal scalability and SNR scalability. SRFGS first simplifies the RFGS temporal prediction architecture and then generalizes the prediction concept as the following: the quantization error of the previous layer can be inter-predicted by the reconstructed image in the previous time instance of the same layer. With this concept, the RFGS architecture can be extended to multiple layers that forming a stack to improve the temporal prediction efficiency. SRFGS can be optimized at several operating points to fit the requirements of various applications while the fine granularity and error robustness of RFGS are still remained. The experiment results show that SRFGS can improve the performance of RFGS by 0.4 to 3.0 dB in PSNR.

### REFERENCE CITED

1. U.S. 20020150158 A1
2. U.S. 20020037046 A1
3. U.S. 20020037047 A1
4. U.S. 20020037048 A1
5. “Streaming video profile—Final Draft Amendment (FDAM 4),” ISO/IEC JTC1/SC29/WG11/N3904, January 2001.
6. H. C. Huang, C. N. Wang, T. Chiang, “A Robust Fine Granularity Scalability Using Trellis Based Predictive Leak,” IEEE Trans. Circuits Syst. Video Technol., vol. 12, pp. 372-385, June 2002.
7. H. C. Huang, C. N. Wang, T. Chiang, and H. M. Hang, “H.26L-based Robust Fine Granularity Scalability (RFGS),” ISO/IEC JTC1/SC29/WG11/M8604, July 2002.
8. Y. He, R. Yan, F. Wu, and S. Li, “H.26L-based fine granularity scalable video coding,” ISO/IEC JTC1/SC29/WG11/M7788, December 2001.
9. M. van der Schaar and H. Radha, “Adaptive Motion-Compensation Fine-Granular-Scalability (AMC-FGS) for Wireless Video,” IEEE Trans. Circuits Syst. Video Technol., vol. 12, pp. 360-371, June 2002.
10. J. W. Wood and P. Chen, “Improved MC-EZBC with Quarter-pixel Motion Vectors” ISO/IEC JTC1/SC29/WG11/M8366, May 2002.
11. A. Golwelkar, I. Bajic, and J. W. Woods, “Response to Call for Evidence on Scalable Video Coding” ISO/IEC JTC1/SC29/WG11/M9723, July 2003.
12. H. C. Huang, W. H. Peng, C. N. Wang, T. Chiang, and H. M. Hang, “Stack Robust Fine Granularity Scalability: Response to Call for Evidence on Scalable Video Coding” ISO/IEC JTC1/SC29/WG11/M9767, July 2003.
13. “Report on Call for Evidence on Scalable Video Coding (SVC) technology,” ISO/IEC JTC1/SC29/WG11/N5701, July 2003.

### FIELD OF THE INVENTION

The present invention relates to an architecture for robust fine granularity scalability (RFGS); more particularly, an architecture that uses block-based motion estimation to remove temporal redundancy and uses DCT transform to remove the spatial redundancy. It is a scalable video coding (SVC) technology that provides fine granularity scalability (FGS) and temporal scalability.

### DESCRIPTION OF THE RELATED ART

The SVC has increasing importance with the rapid growing of multimedia applications over Internet and wireless channels. In such applications, the video information may be transmitted over error-prone channels with fluctuated bandwidth and will be consumed through different networks to diverse devices. To serve multimedia applications under a different environment, the MPEG-4 committee has developed the FGS that provides a DCT-based scalable approach in a layer fashion. The base layer is coded by a non-scalable MPEG-4 advanced simple profile (ASP) while the enhancement layer is intra coded with embedded bitplane coding to achieve FGS. The lack of temporal prediction at FGS enhancement layer leads to inherent robustness, but decreases the coding efficiency.

The attempt to improve the temporal prediction efficiency, as exemplified by the following references:
A) H. C. Huang, C. N. Wang, T. Chiang, “A Robust Fine Granularity Scalability Using Trellis Based Predictive Leak,” IEEE Trans. Circuits Syst. Video Technol., vol. 12, pp. 372-385, June 2002;
B) H. C. Huang, C. N. Wang, T. Chiang, and H. M. Hang, “H.26L-based Robust Fine Granularity Scalability (RFGS),” ISO/IEC JTC1/SC29/WG11/M8604, July 2002;
C) Y. He, R. Yan, F. Wu, and S. Li, “H.26L-based fine granularity scalable video coding,” ISO/IEC JTC1/SC29/WG11/M7788, December 2001p; and
D) M. van der Schaar and H. Radha, “Adaptive Motion-Compensation Fine-Granular-Scalability (AMC-FGS) for Wireless Video,” IEEE Trans. Circuits Syst. Video Technol., vol. 12, pp. 360-371, June 2002.

That disclosed to improve the temporal prediction efficiency while still maintaining the fine granularity and robustness of MPEG-4 FGS. In these approaches, the RFGS multiplies the temporal prediction information with a leaky factor a, where 0 £ a £ 1, to strengthen the error resilience and lead to good tradeoff between coding efficiency and error robustness. In this structure, the base layer quantization error (QE), which is intra coded in the MPEG-4 FGS scenario, is inter predicted by the enhancement layer information to remove the temporal redundancy. In MPEG-4 FGS, the QE has not use the temporal prediction so the compression efficiency is not good. In RFGS, when only partial enhancement layer reference information is received at the decoder side, the leaky factor a is used to attenuate the drift error. The smaller the leaky factor a is, the less amount of mismatch between encoder and decoder when drift error occurs. Smaller a will lead to lower performance when all reference enhancement layer information is received. This is because the temporal predicted information is strongly attenuated by a and only a small part of the temporal redundancy is removed. The other factor b, which denotes the number of bitplanes used in the enhancement layer prediction loop, plays a key role in RFGS structure, too. The larger value of b is, the more the enhancement layer information will be used in the enhancement layer prediction loop. With the removal of more temporal redundancy, larger b provides better performance when all the reference bitplanes are fully reconstructed. However, larger b may lead to larger drift error at lower bitrate, because less amount of required reference information is available for motion compensation. Briefly, smaller b can reduce the drift error at lower bitrate with the sacrifice of coding efficiency since the remaining N-b bitplanes in the enhancement layer do not use the temporal prediction, which significantly degrades the coding performance as that in the MPEG-4 FGS.

Except the SVC technologies that are DCT-base and have temporal prediction feedback loop, there is another active and effective approach, which is three-dimensional (3-D) subband/wavelet coding using a motion compensated temporal filter (MCTF), as disclosed in J. W. Wood and P. Chen, “Improved MC-EZBC with Quarter-pixel Motion Vectors” ISO/IEC JTC1/SC29/WG11/M8366, May 2002. The 3-D wavelet coding uses the MCTF to reduce the temporal redundancy of neighboring frames and applies the wavelet transform to reduce spatial redundancy. 3-D wavelet coding can generate fully embedded bitstreams in both quality and spatio-temporal resolutions. To provide good coding efficiency, however, this approach causes significant coding delay and uses a huge volume of frame memories (i.e. frame buffer). For example, when coding at 30 frames per second and with Group-of-Pictures (GOP) size equal to 32 frames, the coding delay is more than 1 second and the coding processing needs 32 frame memories with each pixel being stored in 4 bytes, as proposed in A. Golwelkar, I. Bajic, and J. W. Woods, “Response to Call for Evidence on Scalable Video Coding” ISO/IEC JTC1/SC29/WG11/M9723, July 2003.

### BRIEF SUMMARY OF THE INVENTION

Therefore, the main purpose of the present invention is to provide a scalable video coding technology that has fine granularity scalability and temporal scalability, can remove more temporal redundancy and reduce more drift error, and can perform optimization at several operating points for various applications.

Another purpose of the present invention is to remove temporal redundancy by block-based motion estimation and the spatial redundancy by DCT transform, which result in short coding delay and a small volume of frame memories. With this lower delay and lower complexity architecture, the present invention is easier to be implemented.

To achieve the above purposes, the present invention is an architecture for Stack RFGS (SRFGS), comprising a base layer, and a plurality of enhancement layers which can be a layer or a plurality of layers extended to form the stack. In the base layer, the original image is predicted by the base layer reconstructed image in the previous time instance. The prediction error will be quantized and encoded into a base layer bitstream. In each enhancement layer, the quantization error will be predicted by the reconstructed image of the same enhancement layer in the previous time instance. Before actually doing the prediction, the prediction image will be multiplied with a leaky factor a of value between zero and 1. The prediction error obtained by the leaky prediction image will use bitplane coding to encode the first several bitplanes into the enhancement layer bitstream. The process of encoding only the first several bitplanes is like the quantization of the base layer, so the quantization error of the enhancement layer will be obtained and be predicted by the next enhancement layer at the previous time instance in the same way.

In the above explanation, firstly, because every enhancement layer is predicted by the reconstructed image of the same enhancement layer in the previous time instance, the temporal redundancy can be reduced and the compression efficiency be improved. Secondly, because a leaky factor a is multiplied with the enhancement layer before prediction and its bitstream is encoded using bitplane coding, FGS is achieved and when there are any errors, thy will be attenuated, which lead to robust error resilience capability. Thirdly, because there is no constrain on the number of the enhancement layer, the coded image can be optimized at several different bitrates for different applications. Fourthly, by using block-based motion estimation to remove the temporal redundancy and by using DCT to remove the spatial redundancy, which are different with using MCTF and wavelet transform in three-dimensional (3-D) subband/wavelet coding, only short coding delay and a small volume of frame memories is required during the encoding and decoding process.

### BRIEF DESCRIPTION OF THE DRAWINGS

The present invention will be better understood from the following detailed description of preferred embodiments of the invention, taken in conjunction with the accompanying drawings, in which

FIG. 1 is a diagram of the prediction concept according to the present invention of SRFGS;

FIG. 2 is a diagram of the SRGFS encoder based on stack concept having a base layer of Advance Video Coding (AVC) according to the present invention;

FIG. 3 is a diagram of the SRGFS decoder based on stack concept having a base layer of AVC according to the present invention; and

FIG. 4 is a diagram of the bitstream format of the SRFGS coding scheme in a frame according to the present invention.

### DESCRIPTION OF THE PREFERRED EMBODIMENT

The following descriptions of the preferred embodiments are provided to understand the features and the structures of the present invention.

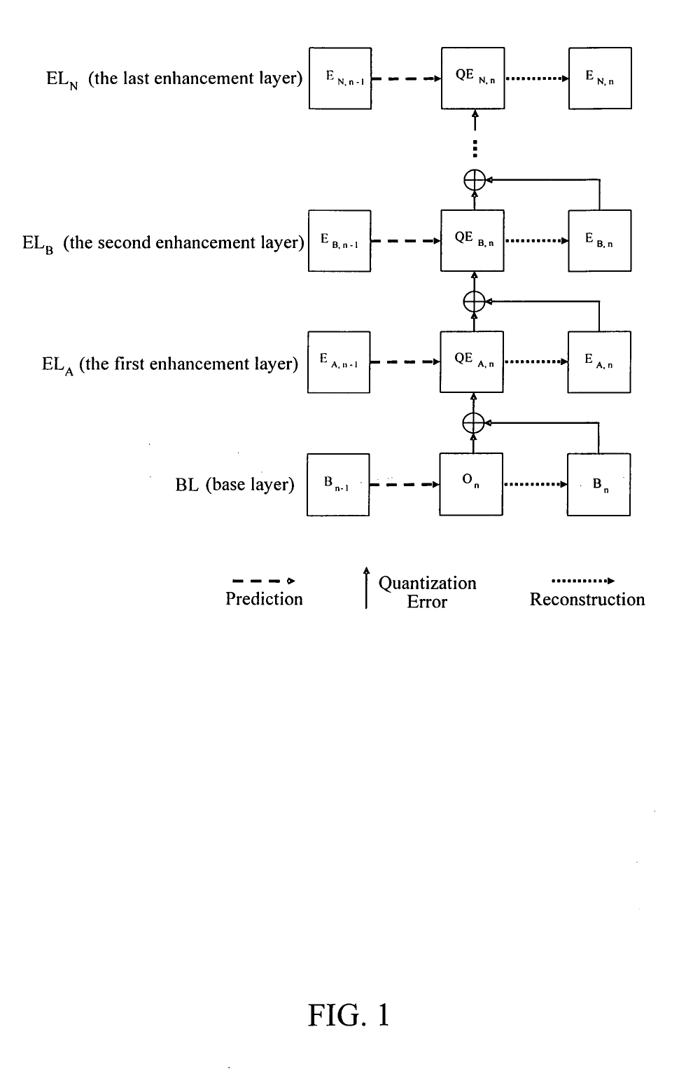

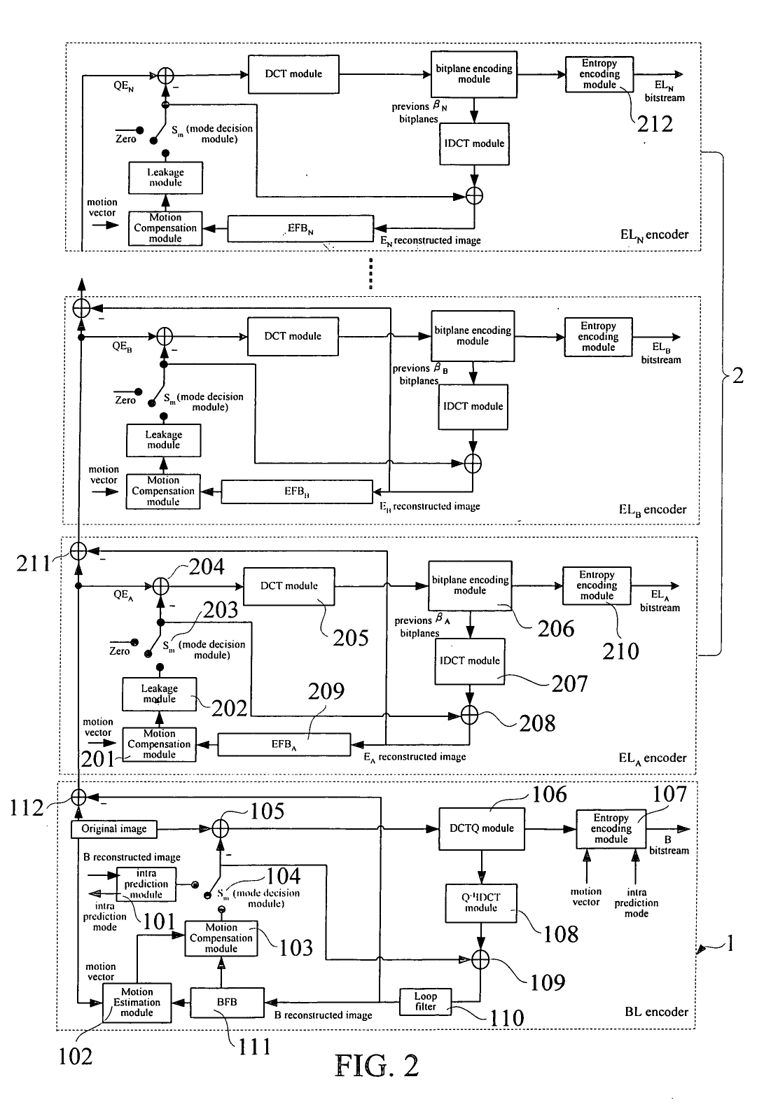

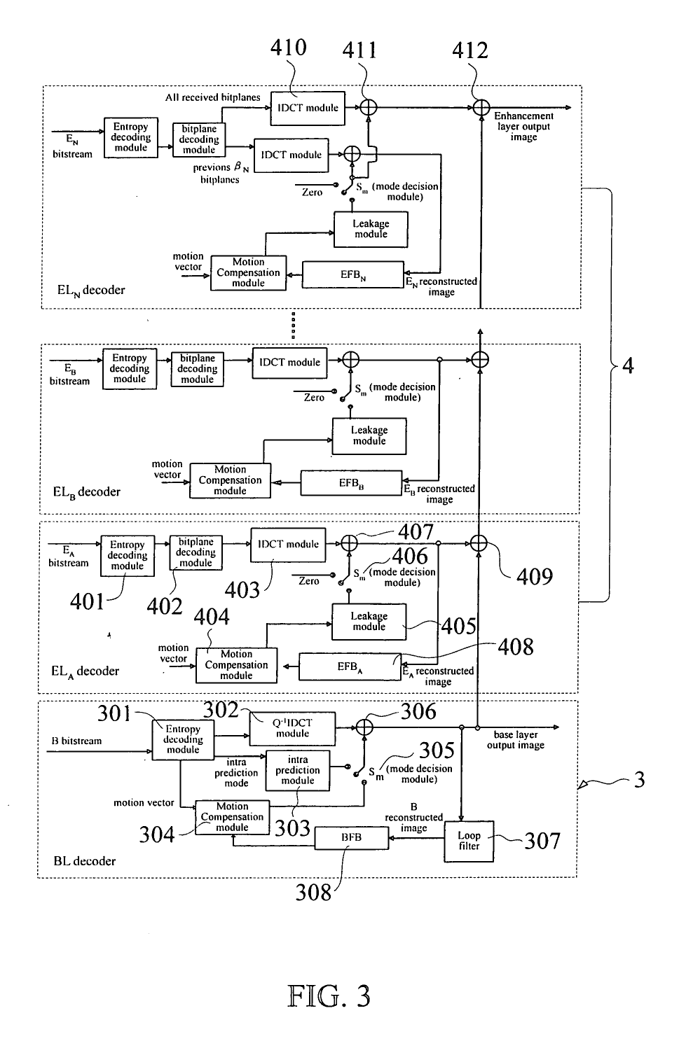

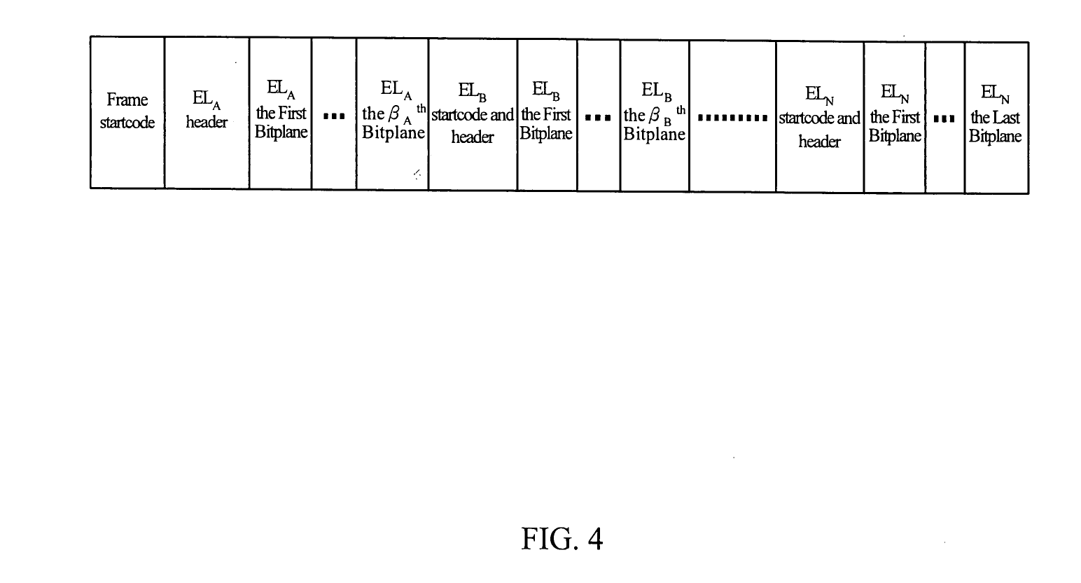

Please refer to FIG. 1 till FIG. 4, wherein FIG. 1 is a diagram of the prediction concept of the SRFGS according to the present invention; FIG. 2 is a diagram of the SRGFS encoder based on stack concept having a base layer of AVC according to the present invention, wherein AVC is one of the newest video compression protocol announced by MPEG committee; FIG. 3 is a diagram of the SRGFS decoder based on stack concept having a base layer of AVC according to the present invention; and FIG. 4 is a diagram of the bitstream format of the SRFGS coding scheme in a frame according to the present invention. Though FIG. 2 and FIG. 3 show the embodiments of SRFGS encoder and decoder based on AVC, the embodiment of a base layer is not limited to be AVC but any coding method using block-based motion estimation to remove temporal redundancy and DCT to remove spatial redundancy, such as those video compression standards of MPEG-1, MPEG-2, MPEG-4, H.261, H.263, etc.

In SRFGS, its prediction concept comes from the following simplified RFGS prediction concept: the quantization error produced by the previous layer can be predicted by the reconstructed image of the same layer in the previous time instance. This simplified prediction concept is further extended to SRGFS that having a plurality of layers, as shown in FIG. 1: At time n, the original Frame Oₙ (the frame to be compressed) is predicted by the base layer reconstructed frame in the previous time instance (time n-1), which is denoted as Bₙ₋₁. The quantization error QE_{A,n} is formed by using the differences between the original Frame Oₙ and the reconstructed base layer Bₙ. The quantization error QE_{A,n} will be predicted by the reconstructed frame of the first enhancement layer ELA at time n-1, which is denoted as E_{A,n-1}. The difference between QEA_{A,n} and the reconstructed first enhancement layer EA n is the quantization error QE_{B,n}. At the second layer EL_{B}, QE_{B,n} can be predicted by the reconstructed frame of the second enhancement layer at time n-1, which is denoted as E_{B,n-1}. Accordingly, so is extended to the N-th Layer, where N is a positive integer no smaller than 1. With this concept, the RFGS enhancement layer prediction scheme can be extended to multiple layers to form a stack. One can find that the coding performance of EL_{A} in SRFGS is as the same as that of the first several bitplanes in RFGS, since the temporal redundancy has been removed in both of them. However, the coding performance in EL_{B} (and all the following layers) of SRFGS is superior to the remaining bitplanes of RFGS, because the temporal redundancy is only removed in SRFGS. The simulation results show that SRFGS can improve the performance of RFGS by 0.4 to 3.0 dB in Peak Signal to Noise Ratio (PSNR).

Based on the stack concept, the AVC-based SRFGS encoder is constructed, as shown in FIG. 2, comprising a base layer encoder 1 and at lease one enhancement layer encoder 2, wherein the enhancement layer encoder 2 comprises one layer or a plurality of layers extended to form a stack. The base layer encoder 1 is to receive an original image and a base layer reconstructed image in the previous time instance. It will obtain a base layer prediction image for predicting the original image and so obtaining a base layer bitstream, a base layer reconstructed image in the present time instance, and a base layer quantization error image obtained by using the differences between the original image and the base layer reconstructed image in the present time instance. And, the base layer encoder 1 comprises an intra prediction module 101, a motion estimation module 102, a motion compensation module 103, a mode decision module 104, two subtraction units 105, 112, a Discrete Cosine Transformation and Quantization (DCTQ) module 106, an entropy encoding module 107, an Inverse Quantization and Inverse Discrete Cosine Transformation (Q⁻¹IDCT) module 108, an addition unit 109, a loop filter 110, and a frame buffer 111. Therein, the intra prediction module 101 uses neighboring pixels in the same image for prediction. The mode decision module 104 select the best prediction mode to obtain the prediction image. The subtraction unit 112 subtracts the base layer prediction image from the original image to obtain a base layer prediction error image. The functions of the other components are the same as those of the same components in an ordinary video encoder.

The enhancement layer encoder 2 comprising a layer or a plurality of layers extended to form a stack is to receive a quantization error image of the previous layer and a reconstructed image of the current layer in the previous time instance; and to obtain a prediction image of the current layer to predict a quantization error image in the previous layer, where the prediction image is generate by applying motion compensation on the reconstructed image of the current layer in the previous time instance; and to obtain the bitstream of the current layer, a reconstructed image of the current layer in the present time instance, and a quantization error image of the current layer. This quantization error image is the differences between the reconstructed image of the current layer and quantization error image of the previous layer. The enhancement layer encoder comprises a motion compensation module 201, a leakage module 202, a mode decision module 203, two subtraction units 204,211, a DCT module 205, a bitplane coding module 206, an Inverse DCT (IDCT) module 207, an addition unit 208, a frame buffer 209, and an entropy encoding module 210,212. Therein, the leakage module 202 is to multiply the prediction image by a leaky factor a no smaller than 0 and no greater than 1. The mode decision module 203 is to select an image of value 0 as the prediction image when the base layer mode decision module 104 decides the prediction mode to be an intra prediction mode, wherein the pixel value of the prediction image in the macroblock is changed to zero. Or, the mode decision module 203 is to select a leaky temporal prediction image as the prediction image when the base layer mode decision module 104 decides the prediction mode to be an inter prediction mode. The bitplane coding module 206 is to distribute the DCT coefficient into bitplanes permuted from the most significant bitplane to the least significant bitplane. All the enhancement layer except the last enhancement layer use entropy encoding module 210 to encode the first b bitplanes and write to the bitstream of the enhancement layer, wherein b is a value between 0 and the maximum bitplane of the current enhancement layer. The last enhancement layer uses the entropy encoding module 212 to encode all biplanes and write to the bitstream of the enhancement layer. These two ways of entropy encoding are identical except whether to encode partial or all bitplanes. The subtraction unit 211 subtracts the quantization error of the previous layer from the reconstructed image of the current layer to obtain a quantization error image of the current layer. Each enhancement layer can have different a and b. The functions of the other components are the same as those of the same components in an ordinary video encoder.

The first enhancement layer of SRFGS, denoted as EL_{A}, is identical to that of RFGS except in two aspects. Firstly, only the first b_{A} bitplanes are encoded by the bitplane coding module 206 and the entropy encoding module 210 and are written into the enhancement layer bitstream. Secondly, the multiplication of the leaky factor a_{A} is moved after the motion compensation module 201. All the enhancement layer loops have the identical architecture as that in EL_{A}, except the last enhancement layer loop EL_{N}. In EL_{N}, the entire residues will be encoded by the bitplane encoding and entropy encoding module to achieve perfect reconstruction at the decoder.

The aforementioned base layer encoder 1 and a plurality of enhancement layers encoder 2 can be applied to form the stack architecture. With the motion vector derived by the motion estimation module that similar with that proposed in “H.26L-based fine granularity scalable video coding” by Y. He, R. Yan, F. Wu, and S. Li, ISO/IEC JTC1/SC29/WG11/M7788, December 2001, the mode decision module will use an AVC-based mode decision method to decide the best mode. By doing so, the same prediction mode and motion vector can be used both in the base layer and all enhancement layer.

Concerning the decoders, as shown in FIG. 3, the decoders comprise a base layer decoder 3 and at least one enhancement layer decoder 4, wherein the enhancement layer decoder 4 can be one layer or a plurality of layers extended to form a stack.

The base layer decoder 3 is to receive a base layer bitstream and the base layer reconstructed image in the previous time instance, where the base layer reconstructed image in the previous time instance is used to obtain a base layer prediction image and a base layer reconstructed image in the current time instance.

The enhancement layer decoder 4 is to receive the enhancement layer bitstream and a reconstructed image of the current layer in the previous time instance. The decoder will obtain a prediction image of the current layer and a reconstructed image of the current layer in the current time instance.

And the base layer decoder 3 further comprises: an entropy decoding module 301 that used to receive a base layer bitstream and decode it into motion vectors, intra prediction modes and quantized base layer DCT coefficients; an Q⁻¹IDCT module 302 to transform the quantized base layer DCT coefficients into a base layer reconstructed prediction error image; an intra prediction module 303 to receive the intra prediction modes and an obtained base layer reconstructed image in the current time instance to obtain a base layer intra prediction image; a motion compensation module 304 to receive the base layer reconstructed image in the previous time instance and the motion vector to obtain a base layer inter prediction image; a mode decision module 305 to receive the base layer inter prediction image and the base layer intra prediction image, and choose one of them to be the base layer prediction image; an addition unit 306 to add the reconstructed prediction error image of the base layer with the base layer prediction image to obtain a base layer unfiltered reconstructed image; a loop filter 307 to filter the unfiltered reconstructed image in the base layer to obtain a base layer reconstructed image in the current time instance; and a frame buffer 308 to store the base layer reconstructed image of the current time instance.

And the enhancement layer decoder 4 further comprises: an entropy decoding module 401 to receive a bitstream of the enhancement layer, decode it into DCT coefficient in bitplane fashion; a bitplane decoder module 402 to receive the DCT coefficient in bitplane fashion, and combined them as the DCT coefficient of the current layer; an IDCT module 403 to transform the DCT coefficient into a reconstructed prediction error image of the current layer; a motion compensation module 404 to receive the reconstructed image of the current layer in the previous time instance and the motion vectors to obtain an inter prediction image of the current layer; a leakage module 405 to multiply the inter prediction image by a leaky factor a to obtain a leaky inter prediction image of the current layer; a mode decision module 406 to receive an image of value 0 and the leaky inter prediction image of the current layer to choose one to be the prediction image of the current layer; an addition unit 407 to add the reconstructed prediction error image of the current layer with the prediction image of the current layer to obtain a reconstructed image of the current layer; and a frame buffer 408 to store the reconstructed image of the current layer. All the enhancement layer decoder, except the last enhancement layer decoder, further comprises an addition unit 409 to add the reconstructed image of the current layer to an aggregate reconstructed image of the previous layer to obtain an aggregate reconstructed image of the current layer. For the first enhancement layer, the aggregate reconstructed image of the previous layer is the base layer reconstructed image at the current time instance. The last enhancement layer decoder further comprises: an IDCT module 410 to inverse transform all the received DCT coefficient of the last enhancement layer into a prediction error image of the last enhancement layer; an addition unit 411 to add the prediction error image of the last enhancement layer to the prediction image of the last enhancement layer to obtain a complete reconstructed image of the last enhancement layer; and an addition unit 412 to add the complete reconstructed image of the last enhancement layer to an aggregate reconstructed image of the previous layer to obtain an aggregate reconstructed image of the last enhancement layer, which is the enhancement layer output image. In the enhancement layer decoders, a is a value no smaller then 0 and no greater than 1, and each enhancement layer can have a different a; and, b is a value no smaller then 0 and no greater than the maximum bitplanes of the current enhancement layer, and each enhancement layer can have a different b.

Briefly, the information received by each enhancement layer loop will be decoded by its own loop and added to the reconstructed image of the base layer to obtain the final output image. For each loop, if only partial bitstream is received, the leaky factor can attenuate the drift error, which is same as in the RFGS case. If there is no information received for a loop, the leaked motion compensated information will be directly stored back to the frame buffer.

In the proposed framework, it is easy to find that the information of each prediction loop is not used or affected by the information in the other loops. Consequently, if there is any error in a loop, it won't affect the data in the other loops. This intrinsic error localization property of SRFGS can have better error resilience capability in an error prone environment.

Besides, one may imagine that more enhancement layer loop will lead to better coding performance. This may not be true in all the cases. Although the temporal prediction can reduce the energy of quantization error, it also increases the dynamic range and provides some extra sign bits. The maximal loop number and the size of each loop should be set adequately for better performance.

FIG. 4 shows the enhancement layer's bitstream format of the SRFGS coding scheme in one frame. Assuming that there is N enhancement layer loops, the bitstream firstly stored all the first b_{A} bitplanes of EL_{A}, which is the most significant information. After b_{A}, we include all the first b_{B} bitplanes of EL_{B}, which is the second most significant information. The similar processes are applied to encode the remaining enhancement layers except the last enhancement layer EL_{N}. For EL_{N}, we store all the bitplanes in the bitstream, not only the first b_{N} bitplanes, and so the image can be fully reconstructed. In all the enhancement layer information, that in the EL_{N} layer is the least significant. Thus, the SRFGS bitstream is ordered by the importance of the information. The FGS server, as how it treats the MPEG-4 FGS and RFGS bitstreams, can truncate the SRFGS bitstream at any point to provide the best performance at that bitrate.

In the present invention, we derived a at macroblock level with a simple optimized method. Here the optimization is in the sense that the handling macroblock has the least prediction error energy.

As shown in FIG. 2, the multiplication of a is placed after the motion compensation module. If the handling macroblock is decided as inter prediction mode at the base layer mode decision module, the enhancement layer encoder will scan all the values between 0 and 1 for a to find the optimal one that minimizes the energy of the prediction error.

Thus, we can find the best a for the handling macroblock in a very simple way. However, the various values of a, which should be coded in the macroblock header, will produce a lot of overhead and will reduce the coding efficiency. In our approach, we further define a frame level a named frame_a. Each enhancement layer will have its own frame_a and is coded at the header of the handling enhancement layer. Each macroblock will choose the best a from 0 and frame_a. Thus for each macroblock, only one-bit flag is needed to indicate whether 0 or frame_a is used. In our simulation, this method provides a good tradeoff between prediction error energy and overhead reduction.

The prediction scheme of B-frame in SRFGS is similar to that in RFGS. In RFGS, the base layer of B-frame is predicted by a high quality reference image that is the summation of the base layer and the enhancement layer reconstructed image, denoted as B+E. In SRFGS structure, The B-frame is predicted by the summation of the base layer and the entire enhancement layer reconstructed image, which is B+E_{A}+ . . . +E_{N}. The quantization error, which is the differences between the original frame and the base layer reconstructed frame, will be coded as the enhancement layer bitstream. That is, there is no stack architecture in B-frame to reduce the coding complexity. Since no other frames will take B-frames as prediction references, dropping some B-frames in the FGS server can provide temporal scalability without any drift error at the remaining frames. The rate control algorithm in SRFGS is identical to that in RFGS, where more bits will be allocated to P-frame at low bitrate to provide a better anchor frame. With this bit allocation, we can reduce the drift error of P-frame and also enhance the reference image quality of B-frame. The extra bits at high bitrate will be allocated to B-frames since the information carried by the more significant bitplane of B-frame is more important than that carried by the less significant bitplane of P-frame.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

1. An architecture of stack robust fine granularity scalability (SRFGS) encoder, comprising:
a base layer encoder; and
at least one enhancement layer encoder,
wherein said base layer encoder is to receive an original image and a base layer reconstructed image in the previous time instance,
wherein said base layer reconstructed image in the previous time instance is to obtain a base layer prediction image for predicting said original image so to obtain a base layer bitstream, a base layer reconstructed image in the present time instance, and a base layer quantization error image obtained by using the difference between said original image and said base layer reconstructed image in said present time instance,
wherein said enhancement layer encoder comprising a layer or a plurality of layers. Each of the said enhancement layer encoder is
to receive a quantization error image of the previous layer and a reconstructed image of said enhancement layer in the previous time instance, and
to obtain a prediction image of said enhancement layer by using said reconstructed image of said enhancement layer in the previous time instance to predict a quantization error image in the previous layer, and
to obtain a bitstream of said enhancement layer, a reconstructed image of said enhancement layer in said present time instance, and a quantization error image of said enhancement layer obtained by using the difference between said quantization error image of said previous layer and said reconstructed image of said enhancement layer in said present time instance.
wherein said previous layer is said base layer as related to the first enhancement layer or is the previous enhancement layer as related to an enhancement layer after the first enhancement layer.

2. The architecture according to claim 1, wherein said base layer encoder further comprises:
an intra prediction module to receive said base layer reconstructed image in said present time instance so to obtain a base layer intra prediction image and a base layer intra prediction mode;
a motion estimation module to receive said original image and a base layer reconstructed image in the previous time instance so to estimate a motion vector;
a motion compensation module to receive said base layer reconstructed image in the previous time instance and said motion vector so to obtain a base layer inter prediction image;
a mode decision module to receive said base layer intra prediction image and said base layer inter prediction image and to choose one image from these two images to be a base layer prediction image;
a subtraction unit to subtract said base layer prediction image from said original image to obtain a base layer prediction error image;
a Discrete Cosine Transformation and Quantization (DCTQ) module to transform said base layer prediction error image into base layer quantized DCT coefficients;
an entropy encoding module to receive said motion vector, said base layer intra prediction mode and said base layer quantized DCT coefficients to encode into a base layer bitstream;
an Inverse-Quantization and Inverse Discrete Cosine Transformation (Q-1IDCT) module to inverse quantization and inverse transform said base layer quantized DCT coefficients into a base layer reconstructed prediction error image;
an addition unit to add said base layer reconstructed prediction error image to said base layer prediction image so to obtain a base layer unfiltered reconstructed image;
a loop filter to filter said base layer unfiltered reconstructed image so to obtain a base layer reconstructed image in said present time instance;
a frame buffer to store said base layer reconstructed image in said present time instance; and
a subtraction unit to subtract said base layer reconstructed image in said present time instance from said original image to obtain a base layer quantization error image.

3. The architecture according to claim 1, wherein each enhancement layer encoder further comprises:
a motion compensation module to receive a reconstructed image of said enhancement layer in the previous time instance and said motion vector generated by said base layer so to obtain an inter prediction image of said enhancement layer;
a leakage module to multiply said inter prediction image of said enhancement layer by a leaky factor a so to obtain a leaky inter prediction image of said enhancement layer;
a mode decision module to receive an image of value 0 and said leaky inter prediction image of said enhancement layer and to choose one image from the above two to be a prediction image of said enhancement layer;
a subtraction unit to subtract said prediction image of said enhancement layer from said quantization error of said previous layer so to obtain a prediction error image of said enhancement layer;
a Discrete Cosine Transformation (DCT) module to transform said prediction error image of said enhancement layer to DCT coefficients of said enhancement layer;
a bitplane coding module to distribute said DCT coefficients of said enhancement layer into different bitplanes permuted from the most significant bitplane to the least significant bitplane;
an Inverse Discrete Cosine Transformation (IDCT) module to transform the DCT coefficients of first b bitplanes into a reconstructed prediction error image of said enhancement layer;
an addition unit to add said reconstructed prediction error image of said enhancement layer to said prediction image of said enhancement layer so to obtain a reconstructed image of said enhancement layer; and
a frame buffer to store said reconstructed image of said enhancement layer.

4. The architecture according to claim 3, wherein any enhancement layer encoder which is not the last enhancement layer further comprises:
an entropy encoding module to encode said first b bitplanes DCT coefficients obtained by said bitplane coding module of said enhancement layer to a bitstream of said enhancement layer; and
a subtraction unit to subtract said reconstructed image of said enhancement layer from said quantization error image of said previous layer so to obtain a quantization error image of said enhancement layer.

5. The architecture according to claim 3, wherein the last enhancement layer further comprises:
an entropy encoding module to encode all bitplane DCT coefficients of said last enhancement layer into a bitstream of said last enhancement layer.

6. The architecture according to claim 3, wherein, in all of the said enhancement layers, a is a value no smaller then zero and no greater than one, and each macroblock in each enhancement layer is able to comprise different a.

7. The architecture according to claim 3, wherein, in all of the said enhancement layers, b is a value no smaller then 0 and no greater than the maximum bitplanes of said DCT coefficients of said enhancement layer, and each said enhancement layer is able to comprise different b.

8. An architecture of SRFGS decoder, comprising:
a base layer decoder; and
at least one enhancement layer decoder,
wherein said base layer decoder is to receive a base layer bitstream and a base layer reconstructed image in the previous time instance to obtain a base layer prediction image and a base layer reconstructed image in the present time instance by using said base layer reconstructed image in the previous time instance,
wherein said enhancement layer decoder comprises a layer or a plurality of layers. Each of the said enhancement layer decoder is
to receive a reconstructed image of the previous layer, and
to obtain a prediction image of said enhancement layer and a reconstructed image of said enhancement layer in said present time instance by using the said reconstructed image of said enhancement layer in the previous time instance, and
wherein said previous layer is said base layer as related to the first enhancement layer or is the previous enhancement layer as related to an enhancement layer after the first enhancement layer.

9. The architecture according to claim 8, wherein said base layer decoder further comprises:
an entropy decoding module to receive a base layer bitstream to decode into a motion vector, a base layer intra prediction mode and a base layer quantized DCT coefficients;
an Q⁻¹IDCT module to inverse quantized and inverse transform said base layer quantized DCT coefficients into a base layer reconstructed prediction error image;
an intra prediction module to receive a base layer intra prediction mode and an obtained base layer reconstructed image in said present time instance so to obtain a base layer intra prediction image;
a motion compensation module to receive said base layer reconstructed image in the previous time instance and said motion vector so to obtain a base layer inter prediction image;
a mode decision module to receive said base layer inter prediction image and said base layer intra prediction image and to choose one image from the above two to be a base layer prediction image;
an addition unit to add said base layer reconstructed prediction error image to said base layer prediction image so to obtain a unfiltered base layer reconstructed image;
a loop filter to filter the said unfiltered base layer reconstructed image so to obtain a base layer reconstructed image in said present time instance; and
a frame buffer to store said base layer reconstructed image in said present time instance.

10. The architecture according to claim 8, wherein each enhancement layer decoder further comprises:
an entropy decoding module to receive a bitstream of said enhancement layer to decode into DCT coefficients for every bitplane of said enhancement layer;
a bitplane decoding module to receive every bitplane obtained by said entropy decoding module to be combined to form DCT coefficients of said enhancement layer;
an IDCT module to transform said DCT coefficients of first b bitplanes of said enhancement layer into a reconstructed prediction error image of said enhancement layer;
a motion compensation module to receive said reconstructed image of said enhancement layer in the previous time instance and a motion vector obtained by said base layer so to obtain an inter prediction image of said enhancement layer;
a leakage module to multiply said inter prediction image of said enhancement layer by a leaky factor a so to obtain a leaky inter prediction image of said enhancement layer;
a mode decision module to receive an image of value 0 and said leaky inter prediction image of said enhancement layer and to choose one image from the above two to be a prediction image of said enhancement layer;
an addition unit to add said reconstructed prediction error image of the said enhancement layer to said prediction image of said enhancement layer so to obtain a reconstructed image of the said enhancement layer; and
a frame buffer to store said reconstructed image of the said enhancement layer.

11. The architecture according to claim 10, wherein any enhancement layer decoder which is not the last enhancement layer decoder further comprises:
an addition unit to add said reconstructed image of said enhancement layer to an aggregate reconstructed image of the previous layer to obtain an aggregate reconstructed image of said enhancement layer. For the first enhancement layer, the said aggregate reconstructed image of the previous layer is the reconstructed image of the base layer.

12. The architecture according to claim 10, wherein the last enhancement layer encoder further comprises:
an IDCT module to transform all the DCT coefficients of said last enhancement layer into a prediction error image of said last enhancement layer;
an addition unit to add said prediction error image of said last enhancement layer to said prediction image of said last enhancement layer to obtain a complete reconstructed image of said last enhancement layer; and
an addition unit to add said complete reconstructed image of said last enhancement layer to an aggregate reconstructed image of the previous layer to obtain an aggregate reconstructed image of said last enhancement layer, which is the enhancement layer output image.

13. The architecture according to claim 10, wherein, in all of the said enhancement layers, a is a value no smaller then 0 and no greater than 1, and each macroblock in each enhancement layer is able to comprise different a.

14. The architecture according to claim 10, wherein, in all of the said enhancement layers, b is a value no smaller then 0 and no greater than the maximum bitplanes of said DCT coefficients of said enhancement layer, and each said enhancement layer is able to comprise different b.
